(19) United States
(12) Patent Application Publication
(10) Pub. No.: US 2007/0263809 A1
(43) Pub. Date: Nov. 15, 2007

(54) Automated rating and removal of offensive ring-back tones from a specialized ring-back tone service

(76) Inventor: Ranjan Sharma, New Albany, OH (US)

Correspondence Address: PATTI , HEWITT & AREZINA LLC, ONE NORTH LASALLE STREET, 44TH FLOOR, CHICAGO, IL, 60602, US

(21) Appl. No.: 11/413,895

(22) Filed: Apr. 28, 2006

(51) Int. Cl. H04M 15/06; H04M 1/56

(52) U.S. Cl. 379/142.01

(57) ABSTRACT

In an embodiment an apparatus may have a dictionary having a plurality of words; and an evaluation engine operatively coupled to the dictionary, and operatively coupled to a repository having a plurality of ring-back tones corresponding to the songs; wherein the evaluation engine implements rating, flagging and filtering out of undesired ring-back tones as a function of a comparison of the words in the dictionary with lyrics associated with the songs to thereby provide acceptable ring-back tones.

### TECHNICAL FIELD

The invention relates generally to ring-back tones personalization service and, more specifically, to a system that automatically filters out and deletes offensive ring-back tones from a repository.

### BACKGROUND

Ring-back tones provide a personalization service, which replaces the standard ring-back tone for calling parties (including friends and family) to enjoy. With this service a subscriber may choose a song for callers to hear before the subscriber picks up the call. The song plays in the call establishment phase, also known as the “ringing” phase.

Typically, ring-back tones may be purchased through the Internet, over the phone and through text messages. Some services may offer the ability to specify a unique ring-back tone to be played during a specific time period. A default ring-back tone may be played during all other times. Ring-back tones may be offered, for example, for different music genres, such as, Rap/Hip-Hop, Pop, Rock, R&B, Alternative, Metal, Classic Rock, Soundtracks & Themes, Country, Voice Tones, Dance, Electronic, Folk, 60's, 70's, 80's, Oldies, Blues, Jazz, Inspirational, World, Latin, Holiday, Sports, TV/Movies, VH1, Comedy Central, etc. Also, a unique ring-back tone may be designated for specific callers or groups of callers.

Specialized ring-back tones were introduced for wireless and wire-line telecommunications service providers a couple years back. It is typical to find that these service providers allow subscribers to choose specialized ring-back tones from a repository containing tens of thousands of ring-back tones.

It is quite cumbersome and time-consuming for a service provider's designated administrative person to listen to each of these tens of thousands of ring-back tones and individually rate these ring-back tones. The ratings could include ring-back tones that are suitable for all ages, or ring-back tones that are suitable for mature audience only etc. Without this rating and verification, however, it is quite likely that calling parties, especially minors, would be subjected to potentially offensive material contained in the ring-back tones. Left unchecked, it is quite possible that calling parties may start an action against the service provider.

One known prior art solution to this problem consists of painstakingly listening to each of the ring-back tones in the repository and evaluation of these “by hand”.

Another possible solution involves the use of a “speech to text” engine that converts the song lyrics, on the fly, to the words of the song. While rating “by hand” is a humongous task (for example, listening to 70,000 ring-back tones, each of 30 seconds duration, would take close to 600 hours of listening) and quite error-prone, the “speech to text” engine usage provides an interesting alternative. However, the specific area where that fails is as follows. Consider a particularly offensive song. Typically only the initial few bars of the song are available for evaluation, and although they may not contain any specific offensive works, they invariably invoke an association with the offensive words to come next.

Another situation occurs where a service provider may have provided a music-only segment, or even removed all words, but still used the background music of an offensive song. As a variation, an instrumental version of a particularly offensive song may be used. A listener might quickly associate the tune with the words. Therefore a “speech to text” engine has significant shortcomings. Finally, a “speech to text” engine can never be perfect; in some cases, suggestive and offensive sounds can't be converted into text; in other cases, this engine can't catch all phrases of a song.

Thus, there is a need in the art for an automated method of rating, flagging and filtering out potentially offensive or undesired ring-back tones.

### SUMMARY

One embodiment of the present method and apparatus encompasses an apparatus. In this embodiment the apparatus may comprise: a dictionary having a plurality of words; and an evaluation engine operatively coupled to the dictionary, and operatively coupled to a repository having a plurality of ring-back tones corresponding to the songs; wherein the evaluation engine implements rating, flagging and filtering out of undesired ring-back tones as a function of a comparison of the words in the dictionary with lyrics associated with the songs to thereby provide acceptable ring-back tones.

Another embodiment of the present method and apparatus encompasses a method. This embodiment of the method may comprise: evaluating lyrics of songs using predetermined words and phrases having respective rating values, the songs being associated with ring-back tones; assigning ring-back tone rating, according to a predetermined set of rules, to the ring-back tones; and deleting ring-back tones based on their assigned rating values.

Another embodiment of the present method and apparatus encompasses a method comprising a blacklist of artist or song titles or song albums, or a combination of all three, that a service provider may deem offensive for the target demographics. The blacklist serves as an exclusion feature for summarily ruling out potentially offensive contents

### DESCRIPTION OF THE DRAWINGS

Features of exemplary implementations of the invention will become apparent from the description, the claims, and the accompanying drawings in which:

FIG. 1 is a representation of one implementation of an apparatus that implements an automated method of rating, flagging and filtering out potentially offensive or undesired ring-back tones;

FIG. 2 depicts one embodiment of the present method that may be utilized with the FIG. 1 system in an initialization stage;

FIG. 3 depicts an example of a dictionary in the FIG. 1 system;

FIG. 4 depicts an example of a table of rules for use by an evaluation engine in the FIG. 1 system; and

FIG. 5 depicts one embodiment of the present method that may be utilized with the FIG. 1 system in an evaluation and removal stage.

### DETAILED DESCRIPTION

In the description below, familiarity with “ring-back tone” service is assumed. In a sentence, a ring-back tone service allows subscribers to replace the ring-back tone a calling party hears with a specialized ring-back tone of their choice (which could be a pop or rock song, for instance, or a famous sentence from a movie like “Make my day, punk” or “I will be back” etc.), unconditionally or conditionally (e.g., on a specific date, on a given day of the week or a specific time range etc.)

Embodiments of the present method and apparatus provide a method to rate and flag ring-back tones. Particularly offensive ring-back tones may be marked for deletion from a ring-back tone repository. This method is automated and requires minimal initial set-up by a human operator. Once it is started, it goes through a repository of ring-back tones, rates each one of them according to the criteria set up and singles out potentially offensive material from among these ring-back tones and removes them.

Embodiments of the method may work with the song title and artist information that is provided as part of each ring-back tone provisioned in the system. The output of this method is assignment of ring-back tone rating (similar to MPAA ratings like G, PG, PG-13, R, X etc.) according to the criteria set by the service provider and removal of ring-back tones from a repository that is above an acceptable rating set by the service provider.

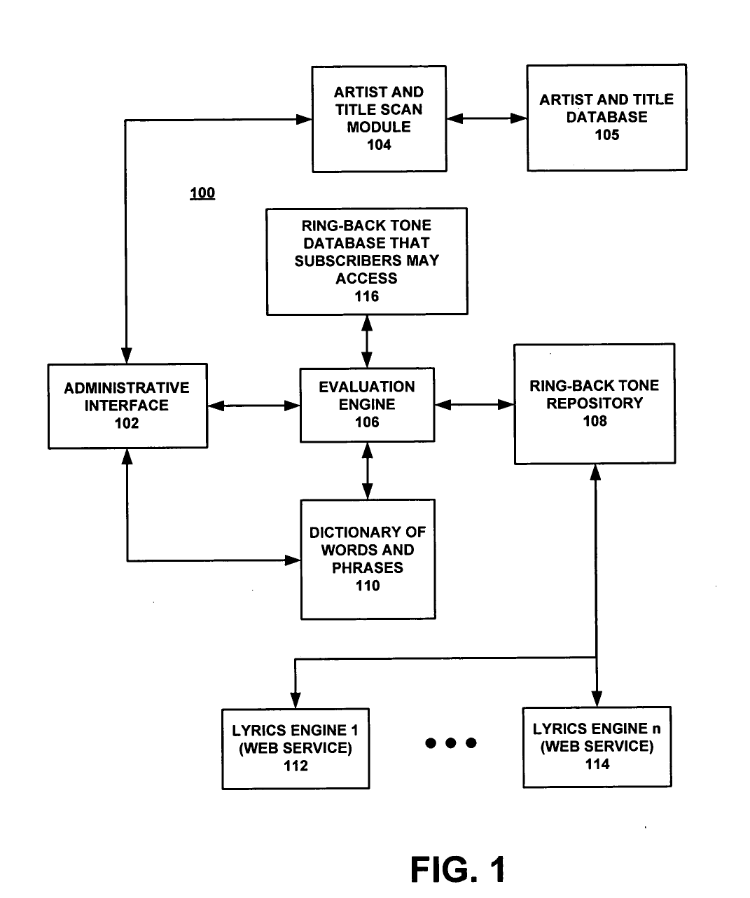

FIG. 1 is a representation of one implementation of an apparatus 100 that implements an automated method of rating, flagging and filtering out potentially offensive or undesired ring-back tones. In the following embodiment, a plurality of songs with respectively associated artists and titles is available, some of which will be selected for use by the service subscriber.

An administrative interface 102 is operatively coupled to an artist and title scan module 104, an evaluation engine 106, and a dictionary 108. The artist and title scan module 104 is operatively coupled to an artist and title database 105, which contains a plurality of artist names and music titles (these represent the superset of titles and artists that would be made available to the subscribers for their use, after pruning the list according to the proposal being made currently). The evaluation engine 106 may be operatively coupled to a repository 108 that contains a plurality of ring-back tones corresponding to songs. The evaluation engine 106 contains the rating and removal rules for selecting ring-back tones from the repository 108. The repository 108 may contain a plurality of available ring-back tones. In some embodiments the repository 108 and the artist and title database 105 may be contained in a common database.

In order to have the evaluation engine 106 select the ring-back tones from the repository 108, a dictionary 110 is populated with words and phrases, each of these words and phrases may be given rating value. As the evaluation engine 106 evaluates each of the ring-back tones stored in the repository, the evaluation engine 106 retrieves, from one or more lyric engines 112, 114, respective lyrics for songs that the ring-backs tones are taken from. The evaluation engine 106 may access the one or more lyric engines 112, 114 via the Internet, for example. Also, the ring-back tone repository 108 may be maintained by another company, and may be also accessed via the Internet, for example.

The evaluation engine 106 may also be operatively coupled to a ring-back tone database 116 that is formed of acceptable ring-back tones that may be accessed by subscribers of the service provider.

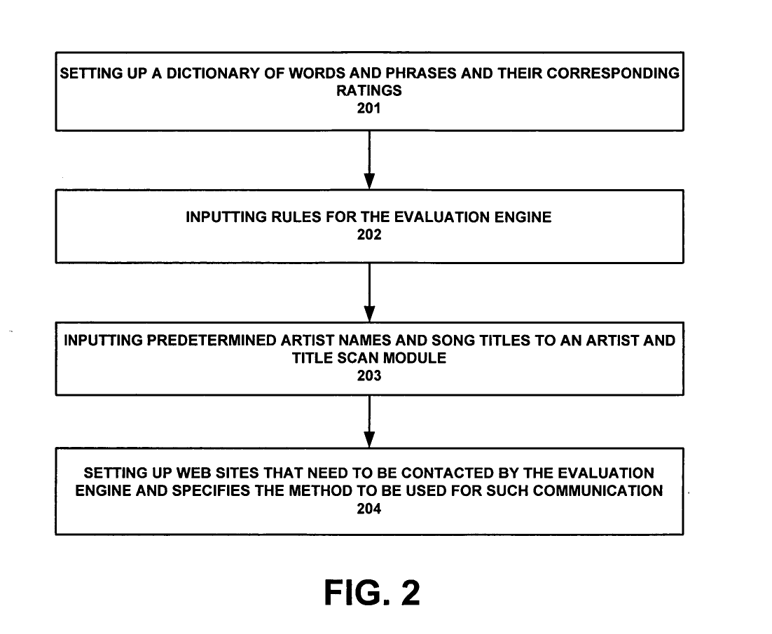

FIG. 2 depicts one embodiment of the present method that may be utilized with the FIG. 1 system in an initialization stage.

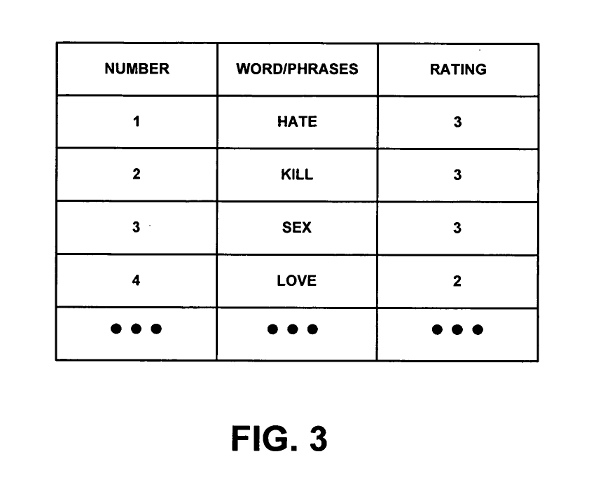

In a first step 201, an administrator (service provider personnel) initializes the dictionary and the rules engine from a web interface. The dictionary of words and phrases and their corresponding ratings that need to be checked are set up. As an example, the administrator would set up the dictionary as depicted in FIG. 3.

This list may be several hundred words/phrases or even longer. Shown in FIG. 3 are only a few and their imaginary ratings. A service provider may mandate that usage of words in a particular song with a rating of 3 or above results in barring usage of that particular song. The actual rules for making that decision would be part of the rules engine.

In a second step 202, the administrator may input the rules for the evaluation engine.

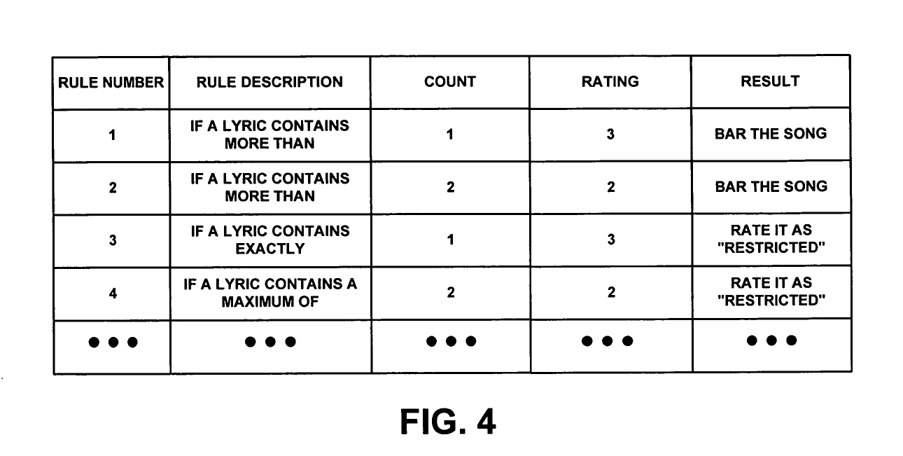

FIG. 4 depicts an example of a table of rules for use by an evaluation engine in the FIG. 1 system. In this example Rule 1 is read as “If a song lyric contains more than 1 Rate-3 words or phrases, the song needs to be deleted”. Rule 2 reads as “If a song lyric contains more than 2 Rate-2 words or phrases, the song needs to be deleted”. A logical combination is also possible with the extension of the table. Such extensions, for example, will provide rules such as “If a song lyric contains exactly 1 Rate-3 word or phrase AND at least 1 Rate-2 word or phrase, the song needs to be deleted”.

In a third step 203, the administrator may also input predetermined artist names and song titles to the artist and title scan module. These artist names and song titles may be the ones that are to be prohibited by the service provider.

In a fourth step 204, the administrator may also set up the web sites that need to be contacted by the evaluation engine and specifies the method to be used for such communication, for example SOAP/XML or a CGI query using HTTP GET, etc.

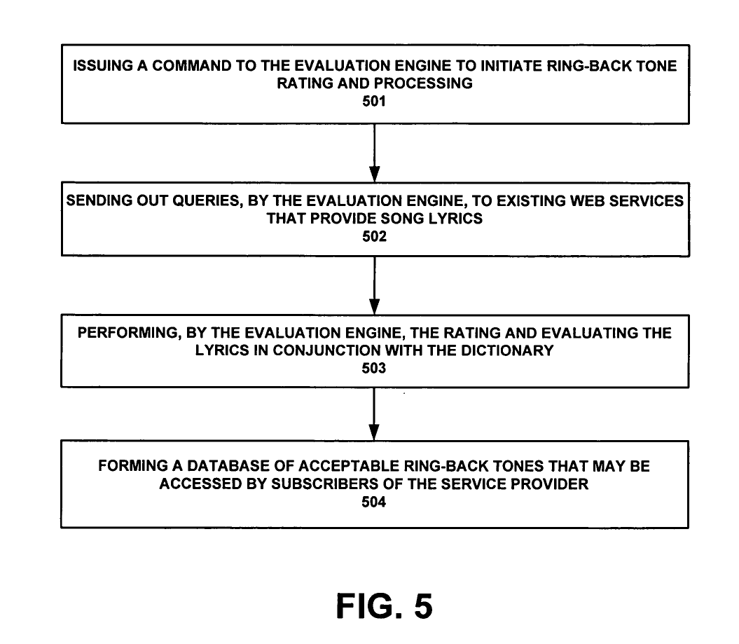

FIG. 5 depicts one embodiment of the present method that may be utilized with the FIG. 1 system in an evaluation and removal stage by an evaluation engine.

In a first step 501, the administrator may issue a command to the evaluation engine to initiate ring-back tone rating and processing. This results in reading the index of ring-back tone repository and picking up unique artist/song title pairs. As an example, if a service provider has provided 10 different segments, each of 25 second duration, of a predetermined song with a predetermined title and predetermined artist, the index read will generate just one value from these 10 ring-back tone segments and the index will be associated with the predetermined artist and title.

Typically, service providers will display the artist name and song title for the subscribers to browse through and click on, via the web interface, to sample the ring-back tone. Given this, the song and artist name are generally available with the specialized ring-back tone solutions. At the end of this first step 501, the rating and removal engine would have a consolidated list of unique artist/song pairs.

In a second step 502, the evaluation engine sends out queries to existing web services that provide song lyrics. For this purpose, any of the established interfaces like SOAP, XML, WSDL could be used. In its simplest form, an HTTP GET command can be issued, or a query constructed to generate the HTML for the lyrics.

Depending on the capability of the system used, the evaluation engine may send one query at a time, or several queries in parallel. Depending on the mode of communication specified in the set up files, the evaluation engine may use the same or different communication mechanism to query the lyrics engines.

At the end of the second step 502, the lyrics for a specific song are available to the evaluation engine. Essentially, each artist/title pair goes through the same processing and follows the same logical steps. For the sake of clarity and brevity, only one thread will be followed here.

In a third step 503, the evaluation engine performs the rating and evaluates the lyrics in conjunction with the dictionary. The result of this processing is the assignment of ring-back tone rating according to the service provider's criteria and deletion of those ring-back tones that are beyond the acceptable ratings.

This step may be computationally intensive. There are ways to speed up the process. Essentially, the process is that of comparing two lists of words. The dictionary may be implemented as an ordered list of words (a b-tree, a binary list, a sequentially linked list, a doubly linked list etc.). However, the song lyrics would arrive as an unordered list of words. If each word of the song is picked up one at a time for comparison, one optimization is to exclude string match of common words like “a”, “an”, “the”, etc. This may be constructed as another “exclusion list”. The area of string comparison, quick search, quick sort is quite mature and implementers may choose any of the available methods.

At the end of the third step, ring-back tones would have been rated as one of the pre-defined ratings. These ratings are added to the ring-back tone manifest, so subscribers can choose wisely and use age-appropriate ring-back tones. Also, songs that are required to be removed may be removed by the evaluation engine.

In a fourth step 504, a ring-back tones database is formed of acceptable ring-back tones that may be accessed by subscribers of the service provider. Each ring-back tone displays its computed rating, as determined by the rating/evaluation engine.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a dictionary having a plurality of words; and
an evaluation engine operatively coupled to the dictionary, and operatively coupled to a repository having a plurality of ring-back tones corresponding to the songs;
wherein the evaluation engine implements rating, flagging and filtering out of undesired ring-back tones as a function of a comparison of the words in the dictionary with lyrics associated with the songs to thereby provide acceptable ring-back tones.

2. The apparatus according to claim 1, wherein the apparatus further comprises an artist and title scan module, wherein the artist and title scan module is operatively coupled to an artist and title database having a plurality of titles of songs and artist names associated with the songs, and wherein the artist and title scan module implements rating, flagging and filtering out of undesired ring-back tones as a function of the titles of songs and the artist names associated with the songs.

3. The apparatus according to claim 1, wherein the evaluation engine has rating and removal rules for selecting ring-back tones from the repository.

4. The apparatus according to claim 1, wherein the dictionary is populated with words and phrases formed from words, each of the words and phrases having a respective rating value.

5. The apparatus according to claim 1, wherein the evaluation engine is operatively coupled to at least one lyric engine that supplies respective lyrics for the songs that are associated with the ring-backs tones.

6. The apparatus according to claim 5, wherein the evaluation engine is operatively coupled to the at least one lyric engine via the Internet.

7. The apparatus according to claim 1, wherein the evaluation engine is also operatively coupled to a ring-back tone database in which is stored the acceptable ring-back tones.

8. An apparatus, comprising:
an administrative interface operatively coupled to an artist and title scan module, an evaluation engine, and a dictionary having a plurality of words;
an artist and title scan module operatively coupled to an artist and title database having a plurality of titles of songs and artist names associated with the songs; and
an evaluation engine operatively coupled to the dictionary, and operatively coupled to a repository having a plurality of ring-back tones corresponding to the songs;
wherein the artist and title scan module implements rating, flagging and filtering out of undesired ring-back tones as a function of the titles of songs and the artist names associated with the songs, and wherein the evaluation engine implements rating, flagging and filtering out of undesired ring-back tones as a function of a comparison of the words in the dictionary with lyrics associated with the songs to thereby provide acceptable ring-back tones.

9. The apparatus according to claim 8, wherein the evaluation engine has rating and removal rules for selecting ring-back tones from the repository.

10. The apparatus according to claim 8, wherein the dictionary is populated with words and phrases formed from words, each of the words and phrases having a respective rating value.

11. The apparatus according to claim 8, wherein the evaluation engine is operatively coupled to at least one lyric engine that supplies respective lyrics for the songs that are associated with the ring-backs tones.

12. The apparatus according to claim 11, wherein the evaluation engine is operatively coupled to the at least one lyric engine via the Internet.

13. The apparatus according to claim 8, wherein the evaluation engine is also operatively coupled to a ring-back tone database in which is stored the acceptable ring-back tones.

14. The method, comprising:
initializing a dictionary by specifying a plurality of words and phrases, each of the words and phases having a respective associate rating value of a plurality of rating values;
initializing an evaluation engine by inputting rules for the evaluation engine;
setting up access to song lyrics and that are contactable by the evaluation engine;
issuing a command to the evaluation engine to initiate ring-back tone rating and processing for a plurality of ring-back tones;
sending out, by the evaluation engine, queries to the web services that provide song lyrics;
performing, by the evaluation engine, the rating and evaluating of the lyrics using the words and phrases and corresponding rating values thereof in the dictionary, and assigning ring-back tone rating according to the rules to the ring-back tones and deleting ring-back tones based on the rating values thereof.

15. The method according to claim 14, wherein the method further comprises inputting predetermined artist names and song titles to an artist and title scan module to an artist and title database having a plurality of titles of songs and artist names associated with the songs, and wherein the artist and title scan module implements rating, flagging and filtering out of undesired ring-back tones as a function of the titles of songs and the artist names associated with the songs.

16. The method according to claim 14, wherein the evaluation engine is operatively coupled to at least one lyric engine that supplies respective lyrics for the songs that are associated with the ring-backs tones.

17. The method according to claim 16, wherein the evaluation engine is operatively coupled to the at least one lyric engine via the Internet.

18. The method according to claim 16, wherein the evaluation engine is also operatively coupled to a ring-back tone database in which is stored the acceptable ring-back tones.

19. The method according to claim 16, wherein the method further comprises forming a ring-back tones database of acceptable ring-back tones that are accessible by subscribers of a service provider.

20. A method, comprising:
evaluating lyrics of songs using predetermined words and phrases having respective rating values, the songs being associated with ring-back tones;
assigning ring-back tone rating, according to a predetermined set of rules, to the ring-back tones; and
deleting ring-back tones based on their assigned rating values.

21. The method according to claim 20, wherein the method further comprises:
initializing a dictionary by specifying a plurality of words and phrases, each of the words and phases having a respective associate rating value of a plurality of rating values;
initializing an evaluation engine by inputting rules for the evaluation engine;
setting up access to song lyrics and that are contactable by the evaluation engine;
issuing a command to the evaluation engine to initiate ring-back tone rating and processing for a plurality of ring-back tones;
sending out, by the evaluation engine, queries to the web services that provide song lyrics;
performing, by the evaluation engine, the rating and evaluating of the lyrics using the words and phrases and corresponding rating values thereof in the dictionary, and assigning ring-back tone rating according to the rules to the ring-back tones and deleting ring-back tones based on the rating values thereof.

22. The method according to claim 20, wherein the method further comprises inputting predetermined artist names and song titles to an artist and title scan module to an artist and title database having a plurality of titles of songs and artist names associated with the songs, and wherein the artist and title scan module implements rating, flagging and filtering out of undesired ring-back tones as a function of the titles of songs and the artist names associated with the songs.

23. The method according to claim 20, wherein the evaluation engine is operatively coupled to at least one lyric engine that supplies respective lyrics for the songs that are associated with the ring-backs tones.
